(19) United States
(12) Patent Application Publication
(10) Pub. No.: US 2019/0002313 A1
(43) Pub. Date: Jan. 3, 2019

(54) SYSTEM AND PROCESS FOR TREATING ALKALINE WASTEWATER

(71) Applicant: NEUTON TECHNOLOGIES INC., TORONTO (CA)

(72) Inventor: DEREK GREGORY ROGERS, TORONTO (CA)

(73) Assignee: NEUTON TECHNOLOGIES INC., TORONTO (CA)

(21) Appl. No.: 15/640,330

(22) Filed: Jun. 30, 2017

(51) Int. Cl. C02F 1/66; C02F 1/00; C02F 1/68; B01F 3/08; B01F 5/06; B01F 13/02

(52) U.S. Cl. CPC C02F 1/66; C02F 1/008; C02F 1/686; C02F 2103/001; B01F 5/0619; B01F 5/0648; B01F 13/0222; B01F 3/0865

(57) ABSTRACT

A system for treating alkaline wastewater includes a first conduit and a second conduit. The first conduit has a first conduit inlet end for receiving alkaline wastewater, a first conduit outlet end for discharging primary treated wastewater, a first conduit upstream portion adjacent the first conduit inlet end, and a first conduit downstream portion adjacent the first conduit outlet end. A first static mixer is in the first conduit. The second conduit has a second conduit inlet end in communication with the first conduit outlet end for receiving the primary treated wastewater, a second conduit outlet end for discharging secondary treated wastewater, a second conduit upstream portion adjacent the second conduit inlet end, and a second conduit downstream portion adjacent the second conduit outlet end. A second static mixer is in the second conduit. A citric acid source is in communication with the first conduit and the second conduit.

### FIELD

This document relates to treatment of alkaline wastewater, such as concrete washout water. More specifically, this document relates to processes and systems for treating alkaline wastewater using citric acid.

### BACKGROUND

U.S. Pat. No. 7,404,926 (Rhoades) discloses a method and a system for treating a fluid containing entrained cementitious particles. The method and system involve drawing the fluid from a storage location, pre-filtering the fluid, and dividing the pre-filtered fluid into a flow of permeate and a flow of bypass by passing the pre-filtered fluid through a tangential flow filter. The permeate flow is fluid that has passed through a polymeric membrane filter media disposed in the tangential flow filter, while the bypass flow is flow exiting said tangential flow filter without passing through said membrane filter media. The system and method also includes a pH probe for testing the pH of the filtrate, and a metering pump operated by a controller which injects a neutralizing agent into the filtrate to reduce the alkalinity of the filtrate before discharge.

### SUMMARY

The following summary is intended to introduce the reader to various aspects of the detailed description, but not to define or delimit any invention.

A system for treating alkaline wastewater is disclosed. According to some aspects, the system includes a first conduit having a first conduit inlet end for receiving alkaline wastewater, a first conduit outlet end for discharging primary treated wastewater, a first conduit upstream portion adjacent the first conduit inlet end, and a first conduit downstream portion adjacent the first conduit outlet end. A first static mixer is in the first conduit. The system further includes a second conduit having a second conduit inlet end in communication with the first conduit outlet end for receiving the primary treated wastewater, a second conduit outlet end for discharging secondary treated wastewater, a second conduit upstream portion adjacent the second conduit inlet end, and a second conduit downstream portion adjacent the second conduit outlet end. A second static mixer is in the second conduit. A citric acid source is in communication with the first conduit and the second conduit.

In some examples, the first conduit extends in a first direction between the first conduit inlet end and the first conduit outlet end, and the second conduit extends in a second direction from the second conduit inlet end to the second conduit outlet end. The second direction may be different from the first direction. The second direction may be opposite to the first direction. The first conduit may extend laterally in the first direction, the second conduit may be spaced vertically from the first conduit, and the second conduit may extend laterally in the second direction.

In some examples, the citric acid source includes a citric acid tank, a first citric acid line connecting the citric acid tank to the first upstream portion, and a first metering pump for metering citric acid from the citric acid tank to the first conduit via the first citric acid line. The system may further include a second citric acid line connecting the citric acid tank to the second upstream portion, and a second metering pump for metering citric acid from the citric acid tank to the second conduit via the second citric acid line.

In some examples, the system includes a first pH sensor in the first conduit downstream portion, and a second pH sensor in the second conduit downstream portion. The system may further include a pH controller. The pH controller may be connected to the first pH sensor and the second pH sensor for receiving a first pH signal from the first pH sensor and a second pH signal from the second pH sensor. The pH controller may be connected to the first metering pump and the second metering pump for metering the citric acid into the first conduit and the second conduit based on the first pH signal and the second pH signal, respectively.

In some examples, the system further includes a gas source in communication with the first conduit upstream portion, for supplying gas to the first conduit upstream portion. The gas source may be a compressed air source.

In some examples, the first static mixer is in the first conduit upstream portion and the citric acid source is in communication with the first conduit upstream portion. In some examples, the second static mixer is in the second conduit upstream portion and the citric acid source is in communication with the second conduit upstream portion.

In some examples, the system further includes a first elbow conduit connecting the first conduit outlet end and the second conduit inlet end.

In some examples, the system further includes a third conduit spaced vertically from the second conduit, the third conduit having a third conduit inlet end in communication with the second conduit outlet end for receiving the secondary treated wastewater, a third conduit outlet end for discharging tertiary treated wastewater, a third conduit upstream portion adjacent the third conduit inlet end, and a third conduit downstream portion adjacent the third conduit outlet end.

In some examples, the system further includes a second elbow conduit connecting the second conduit outlet end and the third conduit inlet end.

In some examples, the system further includes a third pH sensor in the third conduit downstream portion.

In some examples, the first conduit has a first conduit length of between about 15 feet and about 30 feet. In some examples, the first conduit has a first conduit length of between about 20 feet and about 25 feet.

In some examples, the second conduit has a second conduit length of between about 15 feet and about 30 feet. In some examples, the second conduit has a second conduit length of between about 20 feet and about 25 feet.

In some examples, the first conduit has a first conduit diameter of between about 1 inch and about 5 inches. In some examples, the first conduit has a first conduit diameter of between about 3 inches and about 4 inches.

In some examples, the second conduit has a second conduit diameter of between about 1 inch and about 5 inches. In some examples, the second conduit has a second conduit diameter of between about 3 inches and about 4 inches.

In some examples, the system further includes a filtration apparatus upstream of the first conduit.

A process for treating alkaline wastewater is also disclosed. According to some aspects, the process includes a) flowing a mixture of alkaline wastewater and citric acid through a first conduit while mixing the citric acid and the alkaline wastewater, to create primary treated wastewater; b) flowing the primary treated wastewater into a second conduit; c) adding additional citric acid to the primary treated wastewater to yield a mixture of citric acid and primary treated wastewater; d) flowing the mixture of citric acid and primary treated wastewater through the second conduit while mixing the citric acid and the primary treated wastewater, to create secondary treated wastewater; and e) discharging the secondary treated wastewater from the second conduit.

In some examples, the process further includes adding a gas to the first conduit. The gas may be compressed air.

In some examples, step a) includes flowing the mixture of alkaline wastewater and citric acid in a first direction, and step d) includes flowing the mixture of citric acid and primary treated wastewater in a second direction different from the first direction. The first direction may be a lateral direction, and the second direction may be a lateral direction opposite to the first direction.

In some examples, step b) includes flowing the primary treated wastewater vertically (e.g. downward or upward) into the second conduit.

In some examples, the process further includes after step e), flowing the secondary treated wastewater in a third direction through a third conduit.

In some examples, the process further includes prior to step a), flowing the alkaline wastewater into the first conduit, and adding the citric acid into the first conduit.

In some examples, the process further includes measuring a pH of the primary treated wastewater. Step c) may include metering additional citric acid into the primary treated wastewater in response to the pH of the primary treated wastewater.

In some examples, step a) includes flowing the first mixture of alkaline wastewater and citric acid through a first static mixer in the first conduit.

In some examples, step d) includes flowing the mixture of citric acid and primary treated wastewater through a second static mixer in the second conduit.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic flow diagram of a system for treating alkaline wastewater; and

FIG. 2 is a partial perspective cutaway view of the upstream portion of the first conduit of the system of FIG. 1.

### DETAILED DESCRIPTION

Various apparatuses or processes will be described below to provide an example of an embodiment of the claimed subject matter. No embodiment described below limits any claim and any claim may cover processes or apparatuses that differ from those described below. The claims are not limited to apparatuses or processes having all of the features of any one apparatus or process described below or to features common to multiple or all of the apparatuses described below. It is possible that an apparatus or process described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

Disclosed herein is a system and a process for treating alkaline wastewater. The alkaline wastewater may be, for example, concrete washout water. The alkaline wastewater may have a pH that is generally considered too high for discharge into a sanitary sewer, e.g. a pH of greater than about 10.5, or too high for discharge into a storm sewer, e.g. a pH of greater than about 8.5. The system and process may treat the alkaline wastewater so that the pH of the resulting treated wastewater is considered suitable for discharge into a sanitary sewer, e.g. less than about 10.5, or suitable for discharge into a storm sewer, e.g. between about 6.5 and 8.5. Furthermore, the system may have a relatively small footprint, and may be wall-mounted, to minimize the amount of space dedicated to the system. Furthermore, the system may treat a relatively large amount of water in a relatively short period of time.

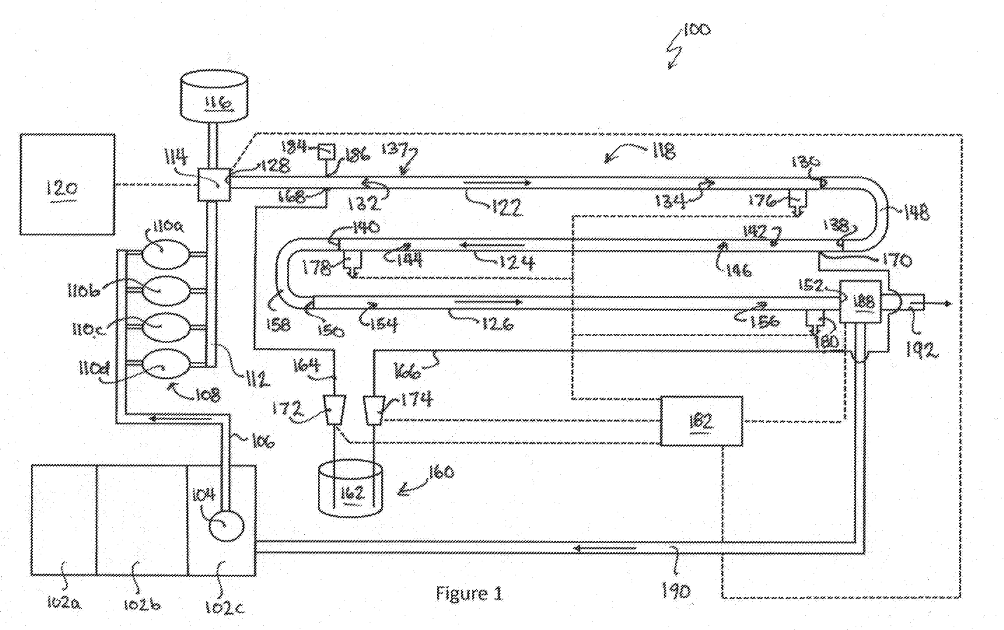

Referring now to FIG. 1, an example system 100 for treating alkaline wastewater is shown. The system 100 is in communication with an alkaline wastewater source, which in the example shown is a series of settling pits 102a, 102b, 102c, containing concrete washout water from, e.g., rain water and/or concrete truck washout. The pH of the alkaline wastewater may be, for example, above about 10.5, or between about 11.5 and 13.8. The system includes a pump 104, which is in communication with the settling pit 102c, for pumping the alkaline wastewater into and through the system 100 via line 106.

In the example shown, line 106 directs the alkaline wastewater to a filtration apparatus 108. The filtration apparatus can include one or more filter chambers in parallel, such as filter chambers 110a, 110b, 110c, and 110d. Each filter chamber 110 can include a filter for removing cement particulate. The filter can be a coarse filter, such as a bag filter, for example a #2 bag filter with a rating of at least 75 microns. In some examples (not shown), a centrifugal filter can be provided upstream of the bag filters. Optionally, the filtration apparatus 108 can include a pressure gauge associated with each chamber to indicate when the filters needs cleaning or replacement. The alkaline wastewater exits the filtration apparatus via line 112.

In the example shown, line 112 directs the alkaline wastewater to a valve 114, which is a three-way valve. The valve 114 can be actuated between a first position, in which alkaline wastewater is directed from line 112 into a recycle tank 116, and a second position in which alkaline wastewater is directed into a treatment section 118 of the system 100. The system 100 includes a controller 120 (also referred to as a programmable logic controller or PLC) connected to the valve 114. The controller 120 can control actuation of the valve, for example depending on the level of wastewater in the settling pits 102.

When the valve 114 is in the second position, the treatment section 118 of the system 100 receives the alkaline wastewater and treats the alkaline wastewater to reduce the pH of the alkaline wastewater. In the example shown, the treatment section 118 includes a first conduit 122, a second conduit 124 downstream of the first conduit 122, and a third conduit 126 downstream of the second conduit 124. As will be described in further detail below, as the alkaline wastewater passes through the conduits 122, 124, 126, the alkaline wastewater is mixed with citric acid, to reduce the pH of the wastewater and at least partially neutralize the wastewater. The conduits 122, 124, 126 have a relatively large combined length, to allow for sufficient mixing and reacting of the citric acid and the wastewater; however, the conduits 122, 124, 126 are configured to reduce the footprint of the system (e.g. can be stacked one above the other).

As used herein, the terms ‘conduit’ and ‘line’ can refer to a single unitary pipe, or to several pipes or sections of pipe that are secured or mounted together.

In the example shown, the first conduit 122 has an inlet end 128 (also referred to as a ‘first conduit inlet end’) for receiving the alkaline wastewater from the valve 114, and an outlet end 130 (also referred to as ‘a first conduit outlet end’) for discharging partially treated alkaline wastewater. The partially treated alkaline wastewater discharged from the outlet end 130 may be referred to herein as ‘primary treated wastewater’. The first conduit 122 further has an upstream portion 132 (also referred to as a ‘first conduit upstream portion’) adjacent the inlet end 128 and a downstream portion 134 (also referred to as a ‘first conduit downstream portion’) adjacent the outlet end 130.

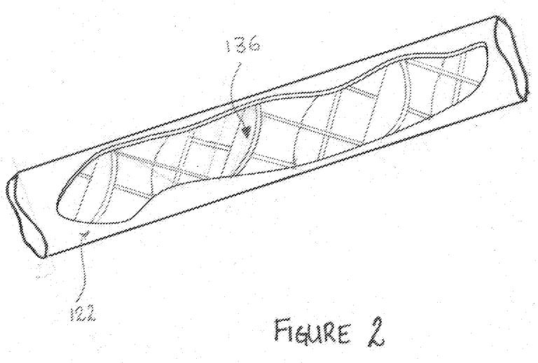

Referring to FIG. 2, a static mixer 136 (also referred to as a first static mixer) is in the first conduit 122, at a location generally indicated by reference character 137 in FIG. 1. In the example shown, the static mixer 136 is in the upstream portion 132 of the first conduit 122.

Referring back to FIG. 1, in the example shown, the second conduit 124 has an inlet end 138 (also referred to as a ‘second conduit inlet end’) in communication with the first conduit outlet end 130 for receiving the primary treated wastewater, and an outlet end 140 (also referred to as ‘a second conduit outlet end’) for discharging further partially treated wastewater. The partially treated wastewater discharged from the second conduit outlet end 140 may be referred to herein as ‘secondary treated wastewater’. The second conduit 124 further has an upstream portion 142 (also referred to as a ‘second conduit upstream portion’) adjacent the inlet end 138 and a downstream portion 144 (also referred to as a ‘second conduit downstream portion’) adjacent the outlet end 140.

In the example shown, a second static mixer is in the second conduit 124. The second static mixer may be of a similar configuration to the first static mixer 136, and is not shown in detail. In the example shown, the second static mixer is in the upstream portion 142 of the second conduit 124, at a position generally indicated by reference numeral 146.

In the example shown, the first conduit 122 is generally horizontal, and extends in a first direction between the first conduit inlet end 128 and the first conduit outlet end 130, to direct the alkaline wastewater laterally in the first direction. The second conduit 124 is also generally horizontal, and extends in a second direction between the second conduit inlet end 138 and the second conduit outlet end 140, to direct the alkaline wastewater laterally in the second direction. The second direction may be different from the first direction, and in the example shown, the second direction is opposite to the first direction. A first elbow conduit 148, having a 180 degree bend, connects the first conduit outlet end 130 and the second conduit inlet end 138.

In the example shown, the first conduit 122 and second conduit 124 are spaced apart in a direction generally transverse to their lengths. Specifically, the first conduit 122 and second conduit 124 extend horizontally, and the second conduit is spaced apart vertically from the first conduit 122. In the example shown, the second conduit 124 is disposed vertically beneath the first conduit 122; however, in alternative examples, the second conduit 124 may be disposed vertically above the first conduit 122. In further alternative examples, the first 122 and/or second 124 conduit may extend generally vertically, and/or the first 122 and second 124 conduits may be spaced apart in the horizontal direction.

In the example shown, the third conduit 126 has an inlet end 150 (also referred to as a ‘third conduit inlet end’) in communication with the second conduit outlet end 140 for receiving the secondary treated wastewater, and an outlet end 152 (also referred to as ‘a third conduit outlet end’) for discharging further treated alkaline wastewater. The further treated alkaline wastewater discharged from the third conduit outlet end 152 may be referred to herein as ‘tertiary treated wastewater’. The third conduit 126 further has an upstream portion 154 (also referred to as a ‘third conduit upstream portion’) adjacent the inlet end 150 and a downstream portion 156 (also referred to as a ‘third conduit downstream portion’) adjacent the outlet end 152.

In the example shown, the third conduit 126 extends in a third direction between the third conduit inlet end 150 and the third conduit outlet end 152. The third direction is generally the same as the first direction and opposite to the second direction. A second elbow conduit 158, having a 180 degree bend, connects the second conduit outlet end 140 and the third conduit inlet end 150.

In the example shown, the third conduit 126 is spaced from the first conduit 122 and the second conduit 124 in a direction generally transverse to their lengths. Specifically, the third conduit 126 is generally horizontal and is spaced apart vertically from the second conduit 124. In the example shown, the third conduit 126 is disposed vertically beneath the second conduit 124; however, in alternative examples, the third conduit 126 may be disposed vertically above the second conduit 124. In further alternative examples, the third conduit 126 may extend generally vertically, and/or may be spaced horizontally from the first 122 and second 124 conduits.

In some examples, the first conduit 122, second conduit 124, and third conduit 126 may have a diameter of between about 1 inch and about 5 inches, or of between about 3 inches and about 4 inches, or of about 3 inches. In some examples, the first conduit, second conduit, and third conduit may each have a length of between about 15 feet and about 30 feet, or between about 20 feet and about 25 feet, or about 22 feet. The first conduit 122, second conduit 124, and/or third conduit 126 may, for example, be made from steel (e.g. mild steel or stainless steel) or PVC.

In some examples, the treatment section 118 may be configured so that the first conduit 122, second conduit 124, and third conduit 126 remain flooded with wastewater during use, to allow for effective mixing by the static mixers. For example, the treatment section 118 may contain an assembly (not shown) for preventing the first conduit 122, second conduit 124, and third conduit 126 from excessively draining.

Referring still to FIG. 1, a citric acid source 160 is in communication with the first conduit 122 and the second conduit 124. In the example shown, the citric acid source 160 includes a tank 162 containing citric acid (also referred to as a ‘citric acid tank’). The citric acid tank 162 may in some examples have a volume of between about 1000 gallons and about 1500 gallons, or about 1200 gallons. The citric acid in the tank may be, for example, up to 50% citric acid, or between 20% and 50% citric acid. A first citric acid line 164 connects the citric acid tank 162 to the upstream portion 132 of the first conduit 122, and a second citric acid line 166 connects the citric acid tank 162 to the upstream portion 142 of the second conduit 124. The first 164 and second 166 citric acid lines may in some examples include polyethylene pipes, which may have a diameter of between about 0.25 inches and about 1.5 inches, or of about 0.5 inches.

In the example shown, the upstream portion 132 of the first conduit 122 has a first injection port 168 for receiving the citric acid from the first citric acid line 164, and the upstream portion 142 of the second conduit 124 has a second injection port 170 for receiving the citric acid from the second citric acid line 166. The injection ports 168, 170 may have, for example, a diameter of between about 0.5 inches and about 1.5 inches, or about 0.75 inches.

In the example shown, a first metering pump 172 is provided for metering citric acid from the citric acid tank 162 to the first conduit 122 via the first citric acid line 164, and a second metering pump 174 is provided for metering citric acid from the citric acid tank 162 to the second conduit 124 via the second citric acid line 166. The metering pumps 172, 174 may be, for example, solenoid driven pumps.

Referring still to FIG. 1, in the example shown, a first pH sensor 176 is in the first conduit downstream portion 134, for measuring the pH of the wastewater as it leaves the first conduit 122 (i.e. for measuring the pH of the primary treated wastewater). A second pH sensor 178 is in the second conduit downstream portion 144, for measuring the pH of the wastewater as it leaves the second conduit 124 (i.e. for measuring the pH of the secondary treated wastewater). A third pH sensor 180 is in the third conduit downstream portion 156, for measuring the pH of the wastewater as it leaves the third conduit (i.e. for measuring the pH of the tertiary treated wastewater). The pH sensors 176, 178, 180 may include, for example, flat tip sensors and HF glass membranes. The pH sensors 176, 178, 180 may be mounted on bottom portions of the conduits 122, 124, 126, respectively, so that they remain in contact with the wastewater.

In the example shown, the system 100 further includes a pH controller 182 (also referred to as a programmable logic controller or PLC), which in the example shown is connected to the first pH sensor 176, the second pH sensor 178, and the third pH sensor 180. The pH controller 182 receives a first pH signal from the first pH sensor 176, a second pH signal from the second pH sensor 178, and a third pH signal from the third pH sensor 180. The pH controller 182 is also connected to the first metering pump 172 and the second metering pump 174, so that citric acid is metered into the first conduit 122 and the second conduit 124 based on the first pH signal and the second pH signal, respectively.

Referring still to FIG. 1, the system further includes a gas source 184, for example a compressed air source. The gas source 184 is in communication with the first conduit upstream portion 132, and supplies gas to the first conduit upstream portion 132. The gas may be added to the first conduit 122 via a gas injection port 186, which may be at the same position along the length of the first conduit 122 as the first citric acid injection port 168. The gas injection port 186 and the first citric acid injection port 168 may in some examples be spaced apart around the circumference of the first conduit 122 by about 180 degrees. The gas may be bubbled through the first conduit 122, and may facilitate mixing of the citric acid and the alkaline wastewater.

Referring still to FIG. 1, in the example shown, a three-way valve 188 is downstream of the third conduit 126. The three-way valve 188 can be moved between a first configuration in which the tertiary treated wastewater is directed from the third conduit 126 back to the source of alkaline wastewater (e.g. if the third pH signal is above a certain threshold) via line 190, and a second configuration in which the tertiary treated wastewater is directed from the third conduit 126 to a sanitary sewer or storm sewer (e.g. if the third pH signal is below a certain threshold) via line 192. The three-way valve 188 may be connected to and controlled by the pH controller 182.

An example of the operation of the system 100 to treat alkaline wastewater will now be described. As a first step, in order to treat the alkaline wastewater, the pump 104 may be turned on, and the valve 114 may be moved to the second position, so that alkaline wastewater is pumped from the source of alkaline wastewater, through the filtration apparatus 108, and into the first conduit 122. The metering pumps 172, 174 may also be turned on to add a start-up dose of citric acid to the first conduit 122 and the second conduit 124. The gas source 184 may be turned on, to add gas to the first conduit 122. The three-way valve 188 may start in the first position.

As the alkaline wastewater enters the first conduit 122, it may combine with the citric acid injected via injection port 168, to form a mixture of alkaline wastewater and citric acid. This mixture may flow through the first conduit 122 in the first direction while being mixed. Specifically, this mixture may flow through the first static mixer 136 and along the length of the first conduit 122, with the gas bubbles enhancing the mixing of the alkaline wastewater and the citric acid. As the mixture flows through the first conduit 122 and is mixed, reaction of the citric acid and the alkaline wastewater may cause partial neutralization of the alkaline wastewater, to lower the pH of the alkaline wastewater and yield primary treated wastewater. The primary treated wastewater may, for example, have a pH of between about 10 and about 12.2.

As the primary treated wastewater exits the first conduit 122, the first pH sensor may measure the pH of the primary treated wastewater, and send a signal to the first metering pump 172 (via the pH controller 182) to adjust the amount of citric acid being added to the first conduit 122, and/or send a signal to the second metering pump 174 (via the pH controller 182) to adjust the amount of citric acid being added to the first conduit 122. For example, if the pH is greater than a first threshold (e.g. if the pH is about 13) the amount of citric acid being added to the first conduit 122 may be increased. If the pH is less than the first threshold, but greater than a second threshold (e.g. if the pH is about 12), the amount of citric acid being added to the second conduit 124 may be increased.

After exiting the first conduit 122, the primary treated wastewater may flow downward via the first elbow conduit 148 into the second conduit 124. In the second conduit 124, additional citric acid may be added to the primary treated wastewater via the second citric acid injection port 170, to yield a mixture of citric acid and primary treated wastewater. Specifically, additional citric acid may be metered into the primary treated wastewater by the second metering pump 174 in response to the pH of the primary treated wastewater. This mixture of primary treated wastewater and additional citric acid may flow through the second conduit 124 in the second direction while being mixed. Specifically, this mixture may flow through the second static mixer, and along the length of the second conduit 124. As the mixture flows through the second conduit 124 and is mixed, reaction of the additional citric acid and the primary wastewater may cause further neutralization, to further lower the pH of the wastewater and yield secondary treated wastewater.

As the secondary treated wastewater exits the second conduit 124, the second pH sensor 178 may measure the pH of the secondary treated wastewater, and send a signal to the first metering pump 172 (via the pH controller 182) to adjust the amount of citric acid being added to the first conduit 122, and/or send a signal to the second metering pump 174 (via the pH controller 182) to adjust the amount of citric acid being added to the second conduit 124. For example, if the pH is less than the first threshold and the second threshold, but greater than a third threshold (e.g. if the pH is about 10), the amount of citric acid being added to the second conduit 124 may be increased.

After being discharged from the second conduit 124, the secondary treated wastewater may flow downward via the second elbow conduit 158 into the third conduit 126. In the third conduit 126, the secondary treated wastewater and remaining citric acid may continue to mix and react as they flow through the third conduit 126 in the third direction. As the mixture flows through the third conduit 126, further neutralization may occur, to further lower the pH of the wastewater and yield tertiary treated wastewater.

As the tertiary treated wastewater exits the third conduit 126, the third pH sensor 180 may measure the pH of the tertiary treated wastewater. If the pH of the tertiary treated wastewater is within a certain range, it may be discharged via three-way valve 188 to the sanitary sewer (e.g. if the pH is between about 6.5 and 10.5) or storm sewer (e.g. if the pH is between about 6.8 and 8.5). If the pH of the tertiary treated wastewater is not within a certain range (e.g. is above about 10.5), it may be routed by three-way valve 188 back to the source of alkaline wastewater. Furthermore, the third pH sensor 180 may send a signal to the first metering pump 172 (via the pH controller 182) to adjust the amount of citric acid being added to the first conduit 122, and/or send a signal to the second metering pump 174 (via the pH controller 182) to adjust the amount of citric acid being added to the second conduit 124. For example, if the pH is above about 10.5, the amount of citric acid being added to the first conduit 122 and the second conduit 124 may be increased.

In some examples, the treatment section 118 of the system 100 may treat between about 2 L and about 10 L of alkaline wastewater per second, or about 5 L of alkaline wastewater per second. In some examples, the passage time through the treatment section 118 of the system 100 may be between about 2 seconds and about 10 seconds, or about 5 seconds.

While the above description provides examples of one or more processes or apparatuses, it will be appreciated that other processes or apparatuses may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A system for treating alkaline wastewater, comprising:
a) a first conduit having a first conduit inlet end for receiving alkaline wastewater, a first conduit outlet end for discharging primary treated wastewater, a first conduit upstream portion adjacent the first conduit inlet end, and a first conduit downstream portion adjacent the first conduit outlet end;
b) a first static mixer in the first conduit;
c) a second conduit having a second conduit inlet end in communication with the first conduit outlet end for receiving the primary treated wastewater, a second conduit outlet end for discharging secondary treated wastewater, a second conduit upstream portion adjacent the second conduit inlet end, and a second conduit downstream portion adjacent the second conduit outlet end;
d) a second static mixer in the second conduit; and
e) a citric acid source in communication with the first conduit and the second conduit.

2. The system of claim 1, wherein the first conduit extends in a first direction between the first conduit inlet end and the first conduit outlet end, and the second conduit extends in a second direction from the second conduit inlet end to the second conduit outlet end, and the second direction is different from the first direction.

3. The system of claim 2, wherein the second direction is opposite to the first direction, and wherein the first conduit extends laterally in the first direction, the second conduit is spaced vertically from the first conduit, and the second conduit extends laterally in the second direction.

4. The system of claim 1, wherein the citric acid source comprises:
a) a citric acid tank;
b) a first citric acid line connecting the citric acid tank to the first upstream portion;
c) a first metering pump for metering citric acid from the citric acid tank to the first conduit via the first citric acid line;
d) a second citric acid line connecting the citric acid tank to the second upstream portion; and
e) a second metering pump for metering citric acid from the citric acid tank to the second conduit via the second citric acid line.

5. The system of any one of claim 4, further comprising a first pH sensor in the first conduit downstream portion, a second pH sensor in the second conduit downstream portion, and a pH controller,
wherein the pH controller is connected to the first pH sensor and the second pH sensor for receiving a first pH signal from the first pH sensor and a second pH signal from the second pH sensor, and wherein the pH controller is connected to the first metering pump and the second metering pump for metering the citric acid into the first conduit and the second conduit based on the first pH signal and the second pH signal, respectively.

6. The system of claim 1, further comprising a gas source in communication with the first conduit upstream portion for supplying gas to the first conduit upstream portion.

7. The system of claim 1 wherein:
a) the first static mixer is in the first conduit upstream portion and the citric acid source is in communication with the first conduit upstream portion; and
b) the second static mixer is in the second conduit upstream portion and the citric acid source is in communication with the second conduit upstream portion.

8. The system of claim 1, further comprising a third spaced vertically from the second conduit, the third conduit having a third conduit inlet end in communication with the second conduit outlet end for receiving the secondary treated wastewater, a third conduit outlet end for discharging tertiary treated wastewater, a third conduit upstream portion adjacent the third conduit inlet end, and a third conduit downstream portion adjacent the third conduit outlet end.

9. The system of claim 8 further comprising a third pH sensor in the third conduit downstream portion.

10. The system of claim 1, wherein at least one of the first conduit and the second conduit has a length of between about 15 feet and about 30 feet.

11. The system of claim 1, further comprising a filtration apparatus upstream of the first conduit.

12. A process for treating alkaline wastewater, comprising:
a) flowing a mixture of alkaline wastewater and citric acid through a first conduit while mixing the citric acid and the alkaline wastewater, to create primary treated wastewater;
b) flowing the primary treated wastewater into a second conduit;
c) adding additional citric acid to the primary treated wastewater to yield a mixture of citric acid and primary treated wastewater;
d) flowing the mixture of citric acid and primary treated wastewater through the second conduit while mixing the citric acid and the primary treated wastewater, to create secondary treated wastewater; and
e) discharging the secondary treated wastewater from the second conduit.

13. The process of claim 12, further comprising adding a gas to the first conduit.

14. The process of any one of claim 12, wherein step a) comprises flowing the mixture of alkaline wastewater and citric acid in a first direction, and step d) comprises flowing the mixture of citric acid and primary treated wastewater in a second direction different from the first direction.

15. The process of claim 14, wherein the first direction is a lateral direction, and the second direction is a lateral direction opposite to the first direction.

16. The process of claim 12, wherein step b) comprises flowing the primary treated wastewater vertically into the second conduit.

17. The process of claim 12, further comprising, after step e), flowing the secondary treated wastewater in a third direction through a third conduit.

18. The process of claim 12, further comprising, prior to step a), flowing the alkaline wastewater into the first conduit, and adding the citric acid into the first conduit.

19. The process of claim 12, further comprising measuring a pH of the primary treated wastewater, wherein step c) comprises metering additional citric acid into the primary treated wastewater in response to the pH of the primary treated wastewater.

20. The process of claim 12, wherein step a) comprises flowing the first mixture of alkaline wastewater and citric acid through a first static mixer in the first conduit, and step d) comprises flowing the mixture of citric acid and primary treated wastewater through a second static mixer in the second conduit.
